(19) United States
(12) Patent Application Publication
(10) Pub. No.: US 2024/0193618 A1
(43) Pub. Date: Jun. 13, 2024

(54) PRODUCT BIO TAG FOR IMPROVED SUPPLY CHAIN TRUST

(71) Applicant: INTERNATIONAL BUSINESS MACHINES CORPORATION, ARMONK, NY (US)

(72) Inventors: Igor S. Ramos, Round Rock, TX (US); Angelo Danducci, II, Austin, TX (US); Kimberly J. Taft, Round Rock, TX (US); Devon E. Mensching, Austin, TX (US)

(21) Appl. No.: 18/063,632

(22) Filed: Dec. 8, 2022

(51) Int. Cl. G06Q 30/018

(52) U.S. Cl. CPC G06Q 30/0185

(57) ABSTRACT

A method, computer system, and a computer program product for product verification is provided. The present invention may include encoding a unique identifier for a product. The present invention may include storing the unique identifier in a shared library. The present invention may include determining a bio-tagging composition for the product. The present invention may include monitoring the product using the bio-tagging composition.

### BACKGROUND

The present invention relates generally to the field of computing, and more particularly to supply chain technology.

In commerce, a supply chain may be a network of facilities which may procure raw materials, transform those raw materials into intermediate goods and eventually final products for customers though a distribution system. A weak link in a product supply chain may be product labels which at any point throughout a supply chain process may be dissociated with a product, rendering upstream information useless.

Accordingly, indelible labels which may provide tamper proof identification which may not be dissociated with an original product and include an embedded timing component may be useful in providing provenance verification throughout a supply chain network.

### SUMMARY

Embodiments of the present invention disclose a method, computer system, and a computer program product for product verification. The present invention may include encoding a unique identifier for a product. The present invention may include storing the unique identifier in a shared library. The present invention may include determining a bio-tagging composition for the product. The present invention may include monitoring the product using the bio-tagging composition.

In another embodiment, the method may include receiving a verification request from at least one participant of a supply chain network.

In a further embodiment, the method may include identifying one or more chemical compounds to be utilized in the bio-tagging composition based on at least properties of the product and a desired half-life.

In yet another embodiment, the method may include providing one or more recommendations to a participant of a supply chain network based on the one or more chemical compounds identified and displaying the one or more recommendations to the participant in a user interface.

In addition to a method, additional embodiments are directed to a computer system and a computer program product for providing product verification throughout a supply chain network.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for product verification according to at least one embodiment.

### DETAILED DESCRIPTION

The following described exemplary embodiments provide a system, method and program product for product verification. As such, the present embodiment has the capacity to improve the technical field of supply chains by providing product verification throughout a supply chain network. More specifically, the present invention may include encoding a unique identifier for a product. The present invention may include storing the unique identifier in a shared library. The present invention may include determining a bio-tagging composition for the product. The present invention may include monitoring the product using the bio-tagging composition.

As described previously, in commerce, a supply chain may be a network of facilities which may procure raw materials, transform those raw materials into intermediate goods and eventually final products for customers though a distribution system. A weak link in a product supply chain may be product labels which at any point throughout a supply chain process may be dissociated with a product, rendering upstream information useless.

Accordingly, indelible labels which may provide tamper proof identification which may not be dissociated with an original product and include an embedded timing component may be useful in providing provenance verification throughout a supply chain network.

Therefore, it may be advantageous to, among other things, encoding a unique identifier for a product, storing the unique identifier in a shared library, determining a bio-tagging composition for the product, and monitoring the product using the bio-tagging composition.

According to at least one embodiment, the present invention may improve the verification of product provenance and reduction of tampering, misrepresentation, and/or substitution of products at various points in a supply chain by determining a bio-tagging composition for the product.

According to at least one embodiment, the present invention may improve product tracking by utilizing a bio-tagging composition determined based on identifying one or more chemical compounds to be utilized in the bio-tagging composition based on at least the properties of the product and a desired half-life.

According to at least one embodiment, the present invention may improve accountability between two or more participants of a supply chain network by using one or more smart contracts to ensure that read out levels for decay of the chemical compound may be within a threshold level of expected decay.

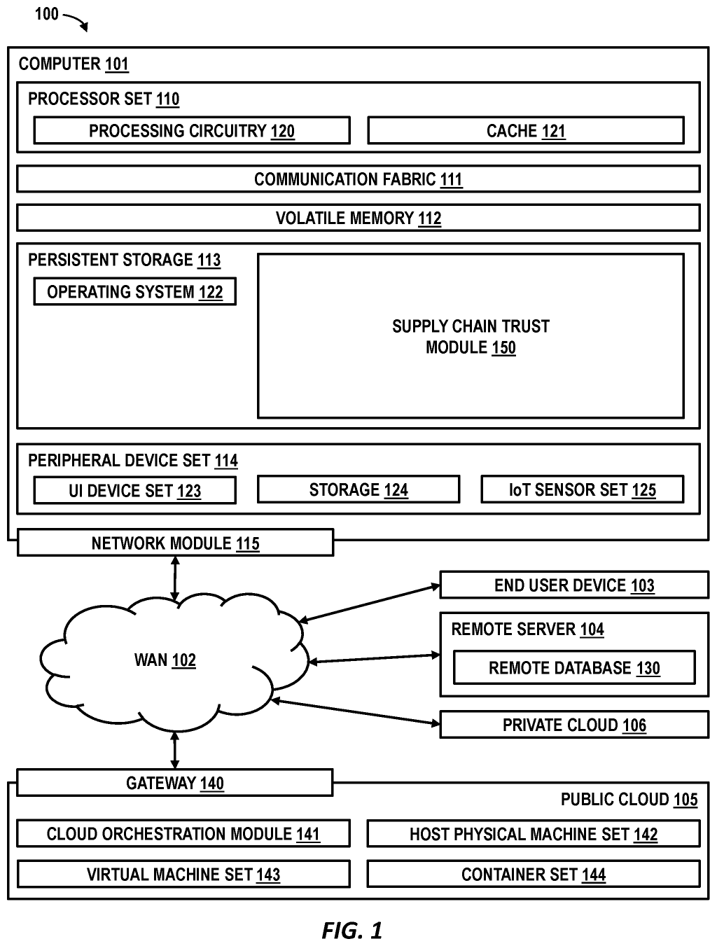

Referring to FIG. 1, Computing environment 100 contains an example of an environment for the execution of at least some of the computer code involved in performing the inventive methods, such as providing product verification throughout a supply chain network using the supply chain trust module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

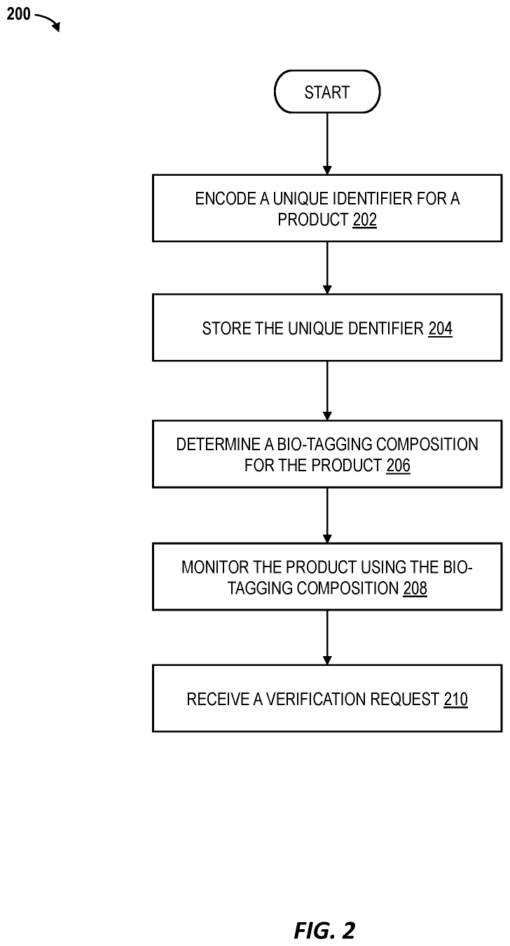

According to the present embodiment, the computer environment 100 may use the supply chain trust module 150 to provide product verification throughout a supply chain network. The product verification method is explained in more detail below with respect to FIG. 2.

Referring now to FIG. 2, an operational flowchart illustrating the exemplary product verification process 200 used by the supply chain trust module 150 according to at least one embodiment is depicted.

At 202, the supply chain trust module 150 encodes a unique identifier for a product. The supply chain trust module 150 may encode the unique identifier for the product in synthetic deoxyribonucleic acid (DNA). The synthetic DNA may be created to encode a unique identifier binary string as a genetic string.

The supply chain trust module 150 may encode the unique identifier for the product in synthetic DNA by translating data into DNA bases which may be synthesized into physical DNA molecules and stored in the shared library. The supply chain trust module 150 may encode the unique identifier for the product in synthetic DNA by utilizing one or more synthesis modules. The one or more synthesis modules may convert ones and zeros of digital data into Adenine (A), Cytosine (C), Guanine (G), and Thymine (T). For example, the supply chain trust module 150 may utilize the one or more synthesis modules in representing binary bits with Adenine being represented as 1 and another nucleotide as 0.

As will be explained in more detail below with respect to step 204, the supply chain trust module 150 may store the unique identifier in a shared library. The shared library may be a supply chain network of at least two participants. Participants of the supply chain network may include, but are not limited to including, individuals, businesses, producers, processors, distributors, retailers, verifiers, amongst other parties which may be involved in the manufacturing, processing, and/or distribution of the product.

At 204, the supply chain trust module 150 stores the unique identifier. The supply chain trust module 150 may store the unique identifier in a shared library. The shared library may be stored on a blockchain, blockchain based distributed ledger (e.g., shared ledger, distributed ledger, Hyperledger), database 130 (e.g., knowledge corpus), amongst other storage mediums.

Each participant of the shared library may utilize independent computers (e.g., nodes). The shared library may be centralized such that one of the one or more participants of the shared library maintains a copy of the shared library, including the same log of transactions and hash values, and no single participant may modify the shared library without a consensus being reached. Each participant of the shared library may have access to the shared library. The shared library may be comprised of at least one or more unique identifiers corresponding to one or more products for which the participants of the shared library may be involved in the manufacturing, processing, and/or distribution.

The supply chain trust module 150 may store the unique identifier using a unique one-way hashing algorithm in generating the hash value. The hash value (c.g., hash) may be a numeric value of a fixed length that uniquely identifies data. Here, the supply chain trust module 150 may utilize the hash value in encoding the DNA bases of the synthetic DNA. The supply chain trust module 150 may utilize a private key and public key pair with a mathematical relationship such that the unique identifier data encrypted with the public key may be decrypted with a corresponding private key. The supply chain trust module 150 may store the hash value on the blockchain, blockchain based distributed ledger (e.g., shared ledger, distributed ledger, Hyperledger), and/or the database 130 (c.g., knowledge corpus). The supply chain trust module 150 may assign the private key for decoding the unique identifier for DNA verification to at least one of the two or more participants of the supply chain network.

At 206, the supply chain trust module 150 determines a bio-tagging composition for the product. The bio-tagging composition determined for the product may be comprised of at least the synthetic DNA and a chemical compound.

The supply chain trust module 150 may identify one or more chemical compounds which may be utilized in the bio-tagging composition based on at least the properties of the product, desired half-life, end user criteria, solubility, resistance to breakdown, amongst other parameters. For example, for oranges, the supply chain trust module 150 may identify tartrazine because the half-life decay is similar to the time to market of oranges, is proven food safe, and could be washed or peeled prior to consumption.

The supply chain trust module 150 may provide one or more recommendations to a participant of the supply chain network based on the one or more chemical compounds identified. The supply chain trust module 150 may display the one or more recommendations to the participant of the supply chain network in a user interface. The participant of the supply chain network which the supply chain trust module 150 may provide the one or more recommendations to may be the same participant assigned the private key for decoding the unique identifier at step 204. The supply chain trust module 150 may display the user interface to the participant on an EUD 103, UI device set 123 of the peripheral device set 114, and/or another device in at least an internet browser, dedicated software application, and/or as an integration with a third party software application, such as, IBM Sterling® Supply Chain Business Network (IBM Sterling and all Sterling-based trademarks are trademarks or registered trademarks of International Business Machines Corporation in the United States, and/or other countries). IBM Food Trust®, IBM Blockchain®, amongst other integrations.

The one or more recommendations may include details with respect to each of the one or more chemical compounds identified, such as, but not limited to, recommended application of the chemical compound, stability of the chemical compound, projected rate of decay of the chemical compound, toxicity, cost, availability, amongst other details. The participant may select the chemical compound to be used in the bio-tagging composition with the user interface using the EUD 103, UI device set 123 of the peripheral device set 114, and/or another device. The supply-chain trust module 150 may store the bio-tagging composition and/or the one or more associated properties of the bio-tagging composition in the shared library.

At 208, the supply chain trust module 150 monitors the product using the bio-tagging composition. The supply chain trust module 150 may monitor the product as it moves through the supply chain based on data received.

The supply chain trust module 150 may monitor the product based on a record application time of the bio-tagging composition to the product by at least one of the two or more participants of the supply chain network. The at least one participant who may apply the bio-tagging composition may be the manufacturer of the product. The participant may record the application of the bio-tagging composition in the user interface along with other details such as, but not limited to, time of application, method of application, amount of the bio-tagging composition applied, location of application, amongst other details. The supply chain trust module 150 may store the details in the shared library utilizing at least the hashing method and/or private key/public key method described in detail above at step 204.

The supply chain trust module 150 may monitor the product based on at least the details recorded with respect to the bio-tagging composition, scans of physical tags associated with the packaging and/or the product itself, as well as IoT data received from a plurality of IoT devices throughout the products life-cycle in the supply chain (e.g., storage, transportation, transfers between participants of the supply chain network), amongst other data which may received and/or stored by the supply chain trust module 150.

The supply chain trust module 150 may monitor the product by determining an expected rate of decay. The supply chain trust module 150 may utilize the details recorded in the shared library by the participant recording the application of the bio-tagging composition and/or the data received from a plurality of IoT devices in determining the expected rate of decay of the chemical compound of the bio-tagging composition. In an embodiment, the supply chain trust module 150 may determine the expected rate of decay based on the half-life of the chemical compound utilized in the bio-tagging composition and/or environmental factors which may impact the rate of decay, environmental factors may include, but are not limited to including, temperature, humidity, amongst other factors which may impact the rate of decay for the chemical compound.

The supply chain trust module 150 may receive data from a plurality of IoT devices in monitoring the product. The one or more IoT devices may be connected to at least one sensor (c.g., temperature sensor, motion sensor, humidity sensor, pressure sensor, accelerometers, gas sensor, multi-purpose IoT sensors, amongst other sensors) which may perform readings throughout the products movement through the supply chain. Each of the plurality of IoT devices may broadcast the data directly to the shared library where it may be recorded on the blockchain, blockchain based distributed ledger (e.g., shared ledger, distributed ledger, Hyperledger), and/or the database 130 (c.g., knowledge corpus). The supply chain trust module 150 may also provide one or more recommendations based on the data received from the one or more IoT devices. For example, based on the deterioration of the synthetic DNA and/or the chemical compound of the bio-tagging composition and/or the data received from the one or more IoT devices, the supply chain trust module 150 may determine the transportation conditions between Participant 4 and Participant 5 of the supply chain network were unfit for the product being transported. The supply chain network 150 may provide this information to all participants of the supply chain network as well as one or more recommendations to improve the transport conditions.

In an embodiment, the supply chain trust module 150 may utilize one or more smart contracts. A smart contract may be a program stored on the blockchain, blockchain based distributed ledger (e.g., shared ledger, distributed ledger, Hyperledger), and/or the database 130 (e.g., knowledge corpus) which may execute automatically based on the fulfillment of predetermined conditions. The smart contract may be between at least two or more of the participants of the supply chain network. For example, the supply chain trust module 150 may attach incentives to the transport conditions of the product. The smart contract may be stored on the blockchain based distributed ledger (e.g., shared ledger, distributed ledger, Hyperledger) and executed based on IoT data received by the supply chain trust module 150.

The expected rate of decay determined by the supply chain trust module 150 may be compared to an actual rate of decay. As will be explained in more detail with respect to step 210, the expected rate of decay and the actual rate of decay may be utilized in responding to a verification request received by the one or more participants of the supply chain network. The supply chain trust module 150 may also utilize the one or more smart contracts in ensuring that read out levels for the actual decay of the chemical compound may be within a threshold level of expected decay. The threshold level may be a readout within an expected range of the mean, such as, plus or minus sigma, wherein sigma may be determined by the supply chain trust module 150 and agreed to between each of the two or more participants of the supply chain network. For example, a successful test (i.e., a passing grade) may be for a threshold level according to the empirical rule (e.g., 68-95-99.7 rule) using sigma in this example as the standard deviation from the expected rate of decay.

At 210, the supply chain trust module 150 receives a verification request. The supply chain trust module 150 may receive the verification request from at least one of the participants of the supply chain network.

The verification request received by the supply chain trust module 150 include, but is not limited to including, a scan of the physical tag associated with the product, images of the product, and/or a bio-tagging composition sample from the product. The supply chain trust module 150 may certify the authenticity of the product using the expected rate of decay and the actual rate of decay received based on the sample of the bio-tagging composition. If the supply chain trust module 150 determines the actual rate of decay deviates greater than a threshold level from the expected rate of decay the supply chain trust module 150 may retrieve additional information stored on the blockchain, blockchain based distributed ledger (e.g., shared ledger, distributed ledger, Hyperledger), and/or the database 130 (e.g., knowledge corpus), such as, but not limited to, IoT sensor data from transportation, storage deviances recorded from previous supply chain steps, amongst other data. The supply chain trust module 150 may also request additional bio-tagging composition samples from additional products within an available batch of products. For example, in a batch of oranges, the supply chain trust module 150 may request the at least one participant sample X number of additional oranges and determine whether the readings of the bio-tagging composition from those oranges brings the mean back within the threshold level of acceptable deviation from the expected rate of decay.

In an embodiment, the verification process may start by receiving a scan of the product's physical tag with the verification request received from at least one of the participants of the supply chain network. The physical tag, may include, but is not limited to including, an RFID tag, a barcode tag, a QR (Quick Response) code tag, a UPC (Universal Product Code) tag, 1D (1 Dimensional) barcodes, 2D (2 Dimensional) barcodes, amongst other labels and/or unique identifiers. The at least one participant of the supply chain network may scan the physical tag associated with the product which may include a variety of information with respect to the product, such as, but not limited to, a one way hash of the unique identifier for the product, encrypted data based on the public/private key cryptography described at step 204, amongst other information which may enable the at least one participant to look up data associated with the product stored on the blockchain, blockchain based distributed ledger (e.g., shared ledger, distributed ledger, Hyperledger), and/or the database 130 (e.g., knowledge corpus). The data associated with the verification request may be displayed by the supply chain trust module 150 to the at least one participant in the user interface on an EUD 103, UI device set 123 of the peripheral device set 114, and/or another device.

In another embodiment, the verification process may start by performing a DNA identity lookup. For example, if there is no tag on the physical product and/or associated with a plurality of products, the supply chain trust module 150 may recover the synthetic DNA sequence associated with the unique identifier of the product. The DNA recovery may be performed by the at least one participant associated with the verification request. The DNA recovery may be performed by swabbing a less frequently abraded surface of the product based on a recommended location provided by the supply chain trust module 150 in the user interface. The recommended location may be provided using a visual display and/or other instructions to the participant of the supply chain network in the user interface. Other instructions may include, but are not limited to including, swab transferring techniques, recommended solutions, amongst other DNA sequencing techniques.

In another embodiment, the verification process may be performed by DNA hash lookup, wherein the hash provided may be a one way hash of the DNA encoded unique identifier as described in more detail above with respect to at least steps 202 and 204. The hash may be stored by the supply chain trust module 150 on the blockchain, blockchain based distributed ledger (e.g., shared ledger, distributed ledger, Hyperledger), and/or the database 130 (c.g., knowledge corpus). The DNA hash lookup may include one or more methods of verification. A first method may include a hashing algorithm which may be named and/or provided on the blockchain and/or shared ledger. In this method, the participant of the supply chain network may recover a local unique identifier associated with the participant utilizing a physical tag and/or the DNA identity lookup. The user may then run the DNA sequenced unique identifier through the hashing algorithm to verify the hash match and verify the provenance of the product. Another method may include using the public/private key cryptography. In this method, a manufacturer and/or other participant of the supply chain network may store an encrypted message intended for the recipient of the product. Under this method, the at least one participant may decrypt the encrypted message using the public key exchange associated with the blockchain, blockchain based distributed ledger (e.g., shared ledger, distributed ledger, Hyperledger), and/or the database 130 (e.g., knowledge corpus).

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for product verification, the method comprising:
encoding a unique identifier for a product;
storing the unique identifier in a shared library;
determining a bio-tagging composition for the product; and
monitoring the product using the bio-tagging composition.

2. The method of claim 1, further comprising:
receiving a verification request from at least one participant of a supply chain network.

3. The method of claim 2, wherein the verification request further comprises:
performing a DNA hash lookup.

4. The method of claim 1, wherein the shared library is a blockchain based distributed ledger.

5. The method of claim 1, wherein determining the bio-tagging composition further comprises:
identifying one or more chemical compounds to be utilized in the bio-tagging composition based on at least properties of the product and a desired half-life.

6. The method of claim 5, further comprising:
providing one or more recommendations to a participant of a supply chain network based on the one or more chemical compounds identified; and
displaying the one or more recommendations to the participant in a user interface.

7. The method of claim 1, wherein monitoring the product further comprises:
receiving data from a plurality of IoT devices; and
determining an expected rate of decay based on the data received from the plurality of IoT devices and a chemical compound of the bio-tagging composition.

8. A computer system for product verification, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
encoding a unique identifier for a product;
storing the unique identifier in a shared library;
determining a bio-tagging composition for the product; and
monitoring the product using the bio-tagging composition.

9. The computer system of claim 8, further comprising:
receiving a verification request from at least one participant of a supply chain network.

10. The computer system of claim 9, wherein the verification request further comprises:
performing a DNA hash lookup.

11. The computer system of claim 8, wherein the shared library is a blockchain based distributed ledger.

12. The computer system of claim 8, wherein determining the bio-tagging composition further comprises:
identifying one or more chemical compounds to be utilized in the bio-tagging composition based on at least properties of the product and a desired half-life.

13. The computer system of claim 12, further comprising:
providing one or more recommendations to a participant of a supply chain network based on the one or more chemical compounds identified; and
displaying the one or more recommendations to the participant in a user interface.

14. The computer system of claim 8, wherein monitoring the product further comprises:
receiving data from a plurality of IoT devices; and
determining an expected rate of decay based on the data received from the plurality of IoT devices and a chemical compound of the bio-tagging composition.

15. A computer program product for product verification, comprising:
one or more non-transitory computer-readable storage media and program instructions stored on at least one of the one or more tangible storage media, the program instructions executable by a processor to cause the processor to perform a method comprising:
encoding a unique identifier for a product;
storing the unique identifier in a shared library;
determining a bio-tagging composition for the product; and
monitoring the product using the bio-tagging composition.

16. The computer program product of claim 15, further comprising:
receiving a verification request from at least one participant of a supply chain network.

17. The computer program product of claim 16, wherein the verification request further comprises:
performing a DNA hash lookup.

18. The computer program product of claim 15, wherein the shared library is a blockchain based distributed ledger.

19. The computer program product of claim 15, wherein determining the bio-tagging composition further comprises:
identifying one or more chemical compounds to be utilized in the bio-tagging composition based on at least properties of the product and a desired half-life.

20. The computer program product of claim 19, further comprising:
providing one or more recommendations to a participant of a supply chain network based on the one or more chemical compounds identified; and
displaying the one or more recommendations to the participant in a user interface.
